(19) United States
(12) Patent Application Publication
(10) Pub. No.: US 2023/0218116 A1
(43) Pub. Date: Jul. 13, 2023

(54) Blender/Juicer Appliance With Safety Latch Arrangement

(71) Applicant: Hamilton Beach Brands, Inc., Glen Allen, VA (US)

(72) Inventor: Brian Bock, Midlothian, VA (US)

(21) Appl. No.: 17/571,649

(22) Filed: Jan. 10, 2022

(51) Int. Cl. A47J 44/00; A23N 1/02; A47J 43/046; A47J 43/07

(52) U.S. Cl. CPC A47J 44/00; A23N 1/02; A47J 43/046; A47J 43/0716

(57) ABSTRACT

A blender/juicer appliance includes: a base including a rotary drive unit; a blender assembly including a blender jar and a blending tool unit, the blending tool unit configured for coupling with the rotary drive unit; a juicer assembly including a juicing bowl and a juicing tool unit, the juicing tool unit configured for coupling with the rotary drive unit; and a latch assembly attached to the base and movable between blending and juicing positions. In the blending position, the latch assembly engages the blender assembly to secure the blender assembly to the base, and in the juicing position, the latch assembly engages the juicer assembly to secure the juicer assembly to the base.

### FIELD OF THE INVENTION

The present invention is directed to small kitchen appliances, and more particularly to combined blender/juicers.

### BACKGROUND

A blender is a household appliance capable of mixing liquids and chopping dry foods. Blenders are also useful for liquefying fruits and vegetables and for blending solids with liquids. A typical blender includes a blender jar assembly comprising a collar and a container that sits on top of a blender base or housing that encloses a motor. The collar includes a blending tool (often a series of blades) rotatably mounted thereto. The blending tool is rotatably engageable with a drive shaft of the motor in an operating configuration. Foodstuff is placed into the container and the blender jar assembly is engaged with the blender base. The foodstuff is blended within the volume defined by the blender jar, and the blender jar assembly is removed from the blender base to dispense or pour the blended foodstuff.

A juicer is a small appliance that extracts juice from fruits and vegetables. Centrifugal juicers use a rapidly spinning cutter/strainer within a housing of the juicer. As the cutter/strainer spins, teeth on the floor of the housing shred the food into a pulp, and centrifugal force pulls the juice out of the pulp and through a perforated wall, where it is funneled out of the juicer via a spigot. Once most of the juice has been extracted, the remaining pulp is ejected into a separate collection chamber.

Appliances that combine blending and juicing functions are known, particularly in smaller (or “personal”) sizes. In one design, in the blender mode, a blender jar fits on the base (often with a coupling collar). A blending tool is mounted on the motor. The blender jar and collar capture the blended foodstuff. In the juicer mode, the user places a “juicer unit” on the base. The juicer unit has a lid with a food chute into which the foodstuff to be juiced is deposited, a pulping/juicing chamber in which juicing occurs, a cutter/strainer mounted on the motor, a pulp outlet for pulp collection, and a juice outlet. Typically, the user can position the aforementioned blender jar below the juice outlet to catch the juice (and in some cases the blender jar may serve as a drinking glass for the juice). Thus, the same base/motor can be employed for both functions.

It may be desirable to employ different and improved designs for a combined blender/juicer.

### SUMMARY

As a first aspect, embodiments of the invention are directed to a blender/juicer appliance. The appliance comprises: a base including a rotary drive unit; a blender assembly including a blender jar and a blending tool unit, the blending tool unit configured for coupling with the rotary drive unit; a juicer assembly including a juicing bowl and a juicing tool unit, the juicing tool unit configured for coupling with the rotary drive unit; and a latch assembly attached to the base and movable between blending and juicing positions. In the blending position, the latch assembly engages the blender assembly to secure the blender assembly to the base, and in the juicing position, the latch assembly engages the juicer assembly to secure the juicer assembly to the base.

As a second aspect, embodiments of the invention are directed to a blender/juicer appliance comprising: a base including a rotary drive unit; a blender assembly including a blender jar and a blending tool unit, the blending tool unit configured for coupling with the rotary drive unit; a juicer assembly including a juicing bowl and a juicing tool unit, the juicing tool unit configured for coupling with the rotary drive unit; and a latch assembly attached to the base and movable between blending and juicing positions, wherein in the blending position, the latch assembly engages the blender assembly to secure the blender assembly to the base, and in the juicing position, the latch assembly engages the juicer assembly to secure the juicer assembly to the base. The latch assembly is configured so that, in the blending position, the latch assembly prevents proper engagement of the juicer assembly with the base.

As a third aspect, embodiments of the invention are directed to a blender/juicer appliance comprising: a base including a rotary drive unit; a blender assembly including a blender jar and a blending tool unit, the blending tool unit configured for coupling with the rotary drive unit; a juicer assembly including a juicing bowl and a juicing tool unit, the juicing tool unit configured for coupling with the rotary drive unit; and a latch assembly attached to the base and movable between blending and juicing positions, wherein in the blending position, the latch assembly engages the blender assembly to secure the blender assembly to the base, and in the juicing position, the latch assembly engages the juicer assembly to secure the juicer assembly to the base. The latch assembly comprises: an arm member configured so that, in the blending position, the arm member engages a feature on the base, and in the juicing position, the arm member engages a feature on the juicer assembly, wherein in the juicing position the arm member is generally inverted from its orientation in the blending position; and a knuckle member that is pivotally attached to the arm member at a first pivot axis and to the base at the second pivot axis. In the blending position, the first pivot axis is above the second pivot axis, and in the juicing position, the second pivot axis is above the first pivot axis.

### BRIEF DESCRIPTION OF THE FIGURES

FIG. 1 is a perspective view of a blender/juicer according to embodiments of the invention, shown in blending mode.

FIG. 2 is a perspective view of the blender/juicer of FIG. 1, shown in juicing mode.

FIG. 3A is a perspective view of the base of the blender/juicer of FIG. 1, with the latching system shown in the blending position.

FIG. 3B is a perspective view of the base of the blender/juicer of FIG. 1, with the latching system shown in the juicing position.

FIG. 4A is a perspective view of the latching system as in FIG. 3A, shown in a blending position for latching the blender jar to the housing.

FIG. 4B is a partial perspective view of the latching system as in FIG. 4A.

FIG. 4C is a perspective view of the latching system as in FIG. 3B, shown in a juicing position for latching the blender jar to the housing.

FIG. 4D is a partial perspective view of the latching system as in FIG. 4C.

FIG. 4E is a greatly enlarged partial perspective view of the spring and slide member of the latching system of FIG. 4C.

FIG. 5 is an enlarged partial perspective view of the blender/juicer of FIG. 1 in its blending mode, showing the latching system employed to latch the blender jar into position.

FIG. 6 is a perspective section view of the blender/juicer of FIG. 1 showing the latching system in the blending position.

FIG. 6A is a bottom perspective view of the blender collar of the blender/juicer of FIG. 1.

FIG. 7 is a perspective view of the blender/juicer of FIG. 1 shown in its juicing mode, with the latching system engaging the juicing lid.

FIG. 8 is a perspective section view of the blender/juicer of FIG. 1, showing the latching system in the juicing position for latching the juicing components to the housing.

FIG. 9 is a partial perspective section view of the blender/juicer of FIG. 1 showing how the latching system prevents the attachment of the juicing bowl to the housing when the latch is in the first position.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

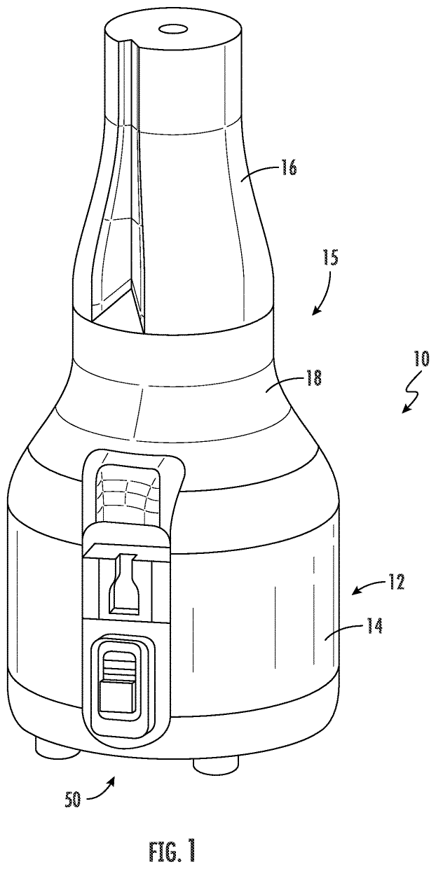

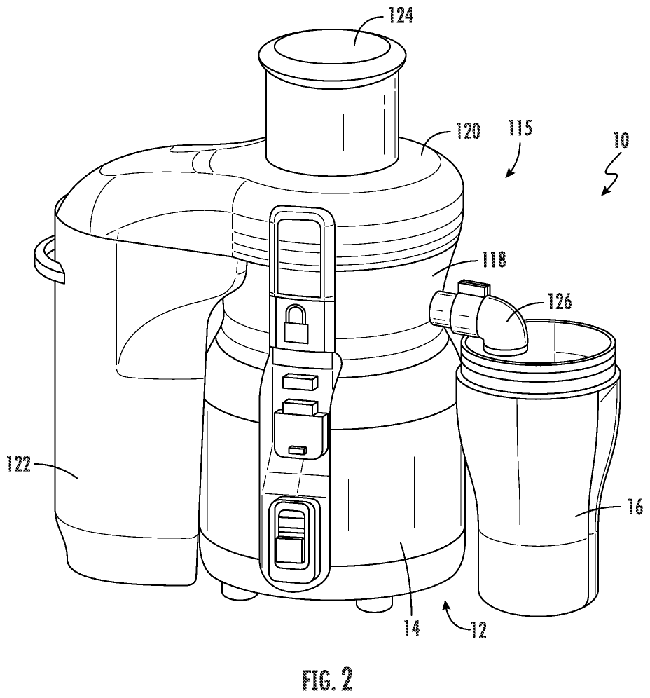

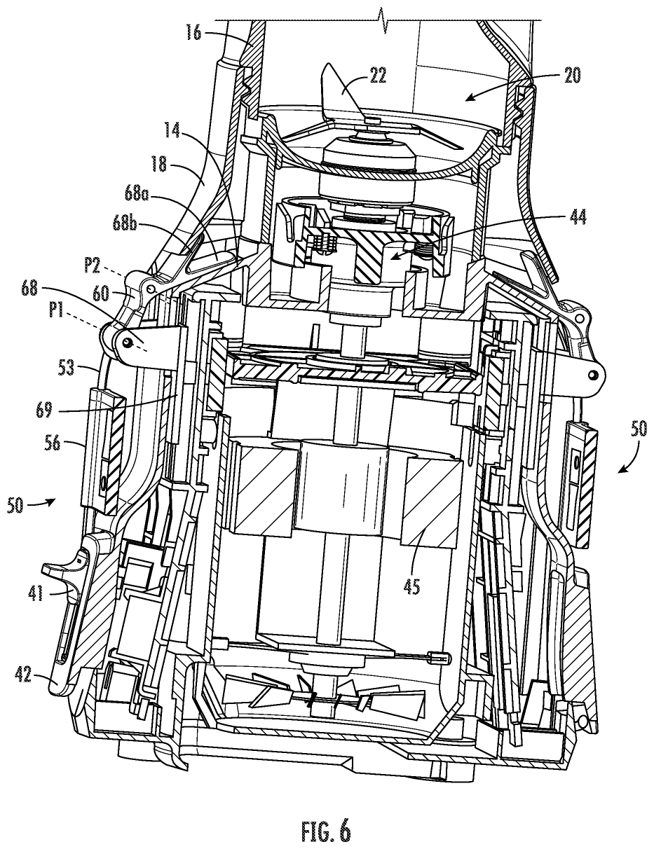

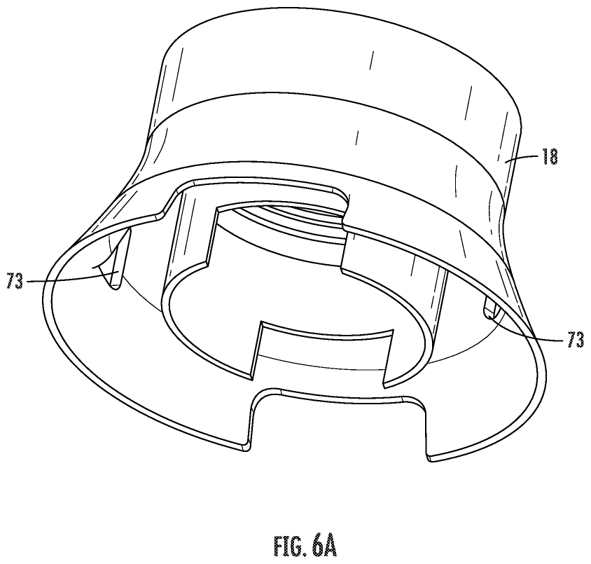

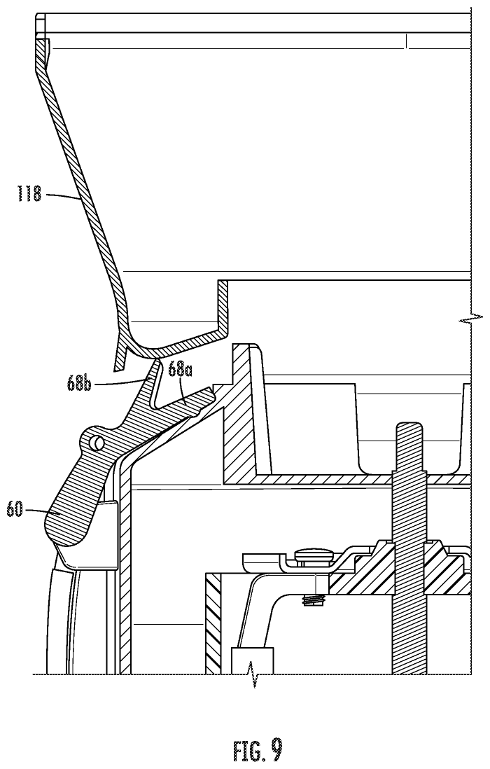

Referring now to the drawings, a blender/juicer, designated broadly at 10, is shown in FIGS. 1 and 2. The blender/juicer 10 is shown in the blending mode in FIG. 1, and in the juicing mode in FIG. 2. As can be seen in FIG. 1, in the blending mode the blender/juicer 10 includes a base 12 covered with a housing 14 and a blender assembly 15 that includes a blender jar 16, a collar 18 that serves as a transition between the base 12 and the blender jar 16, and a blending tool unit 20 (not shown in FIG. 1, but visible in FIG. 6). As shown in FIG. 2, in the juicing mode the blender/juicer 10 includes a juicing assembly 115 that comprises a juicing bowl 118, a juicing lid 120, a pulp receptacle 122, a pusher 124, and a juicing tool unit 130 (not shown in FIG. 2, but visible in FIG. 9). As shown in FIG. 2, the blender jar 16 may serve as a receptacle for juice once it is produced. It will be understood that, in the blending mode, the juicing bowl 118, juicing lid 120, pulp receptacle 122, pusher 124, and juicing tool unit 130 are not employed, and in the juicing mode, the collar 18 and blending tool unit 20 are not employed.

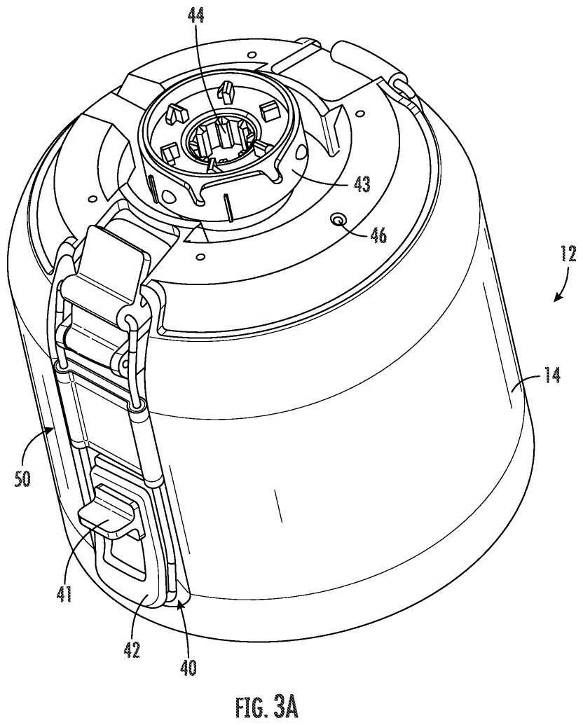

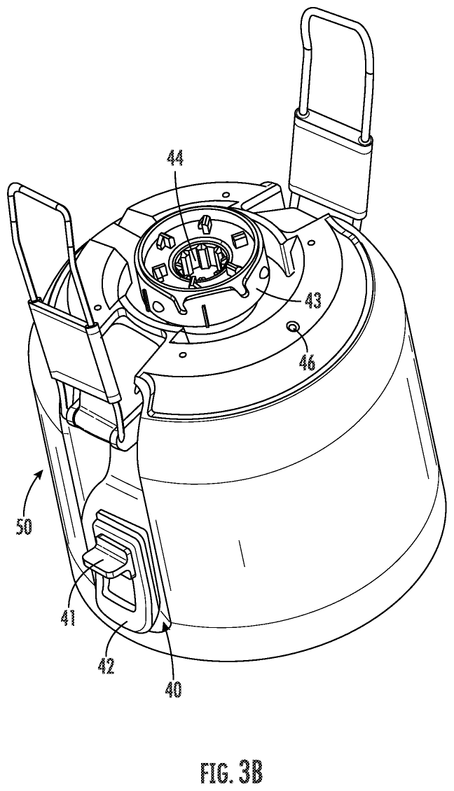

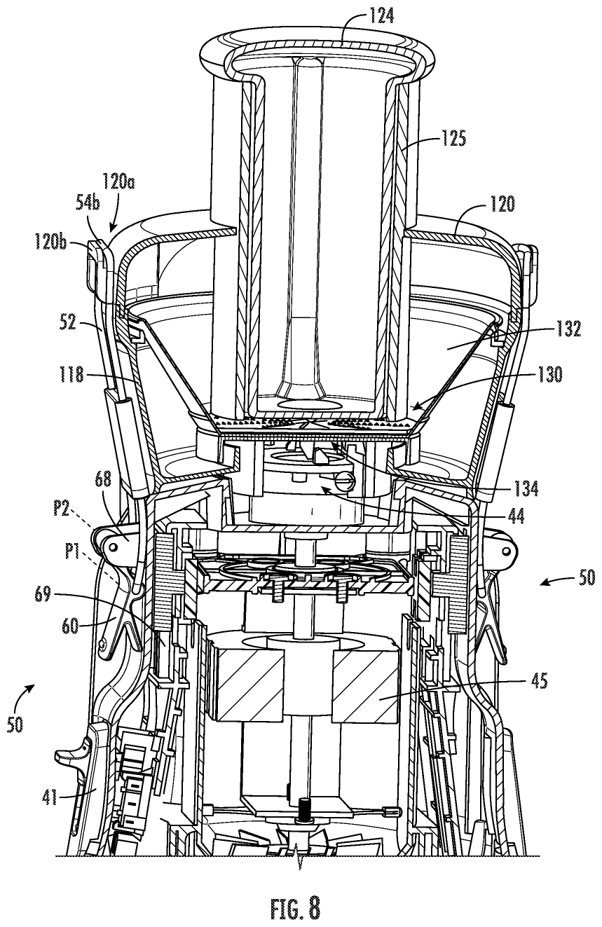

Referring now to FIGS. 3A and 3B, the base 12 is shown therein. As shown therein, the housing 14 is generally cylindrical, and includes a recess 40 on each side for receiving a latching system 50. An operating switch 41 and surrounding frame 42 are mounted within one of the recesses 40. On its top surface, the base 12 includes a ring 43 that surrounds a fitting 44. As can be seen in FIGS. 6 and 8, the fitting 44 is attached to the motor 45 (or other rotary drive unit) positioned within the housing 14. The fitting 44 serves as an interface to both the blending tool unit 20 (as shown in FIG. 6) and to the juicing tool unit 130 (as shown in FIG. 8). The operating switch 41 is operatively connected with the motor 45 via wiring, controls, microprocessors, etc. to enable the user to operate the blender/juicer at different speeds. Also, a small hole 46 is present in the upper surface; the hole 46 leads to a switch (not shown) that functions as a safety switch in the blending mode.

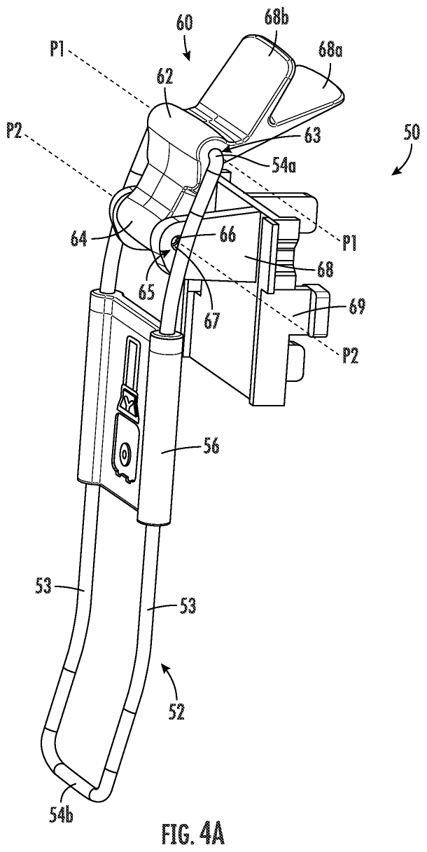

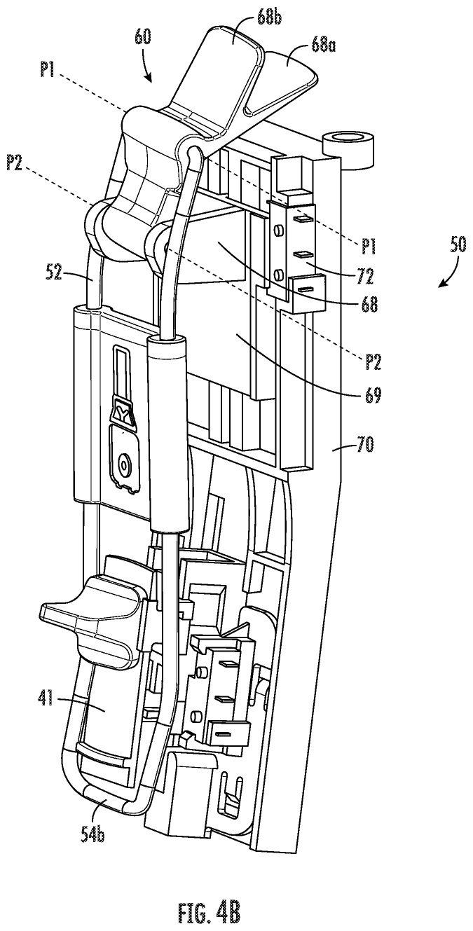

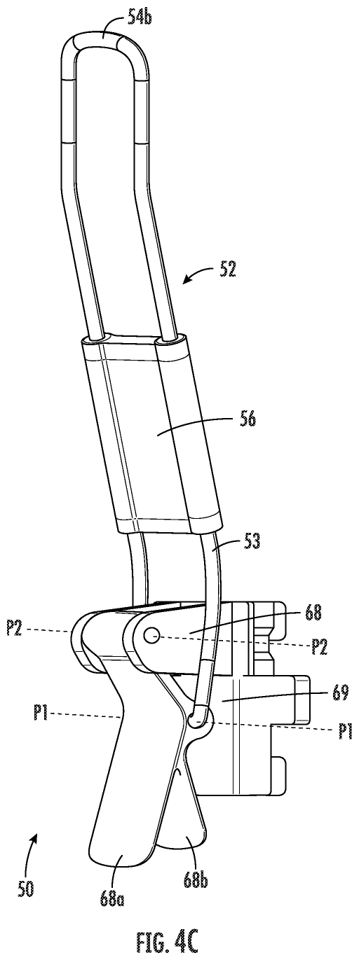

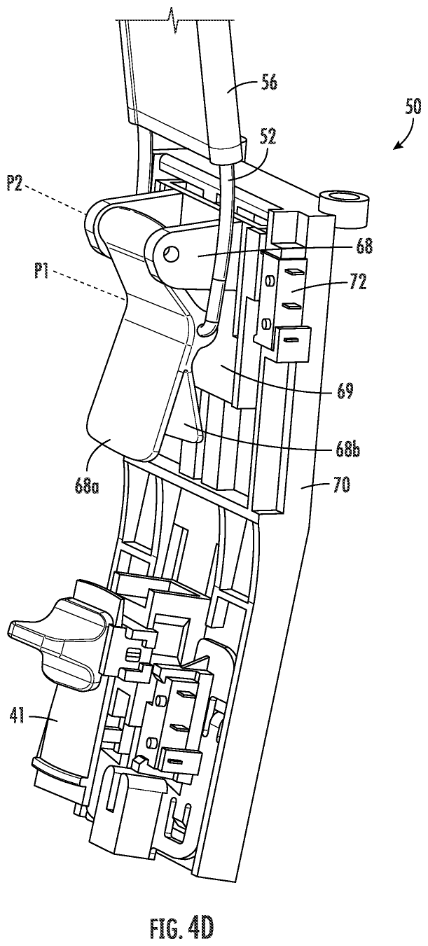

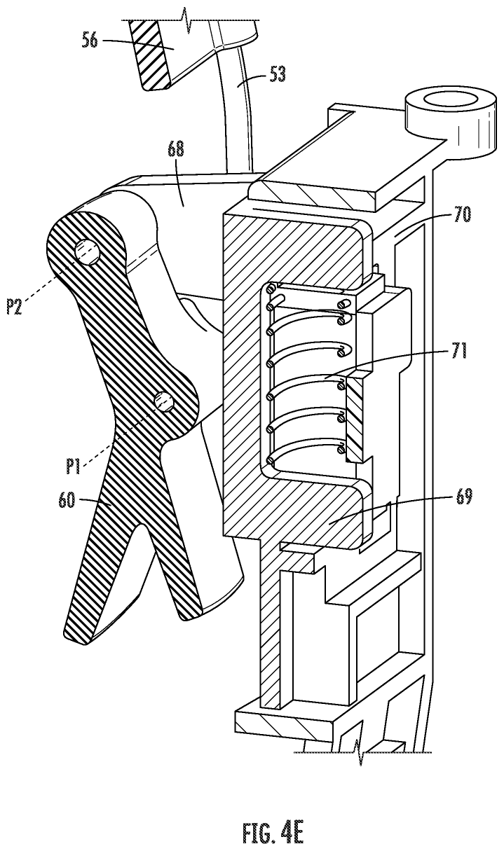

Referring now to FIGS. 4A-4E, the latching system 50 is shown therein. The latching system 50 is configured to move between a blending position (FIGS. 4A and 4B), in which it captures the collar 18, and a juicing position (FIGS. 4C-4E), in which it captures the juicing bowl 118 and lid 120. The blender/juicer 10 includes two latching systems 50 (one in each recess 40) that are essentially identical; as such, only one latching system 50 will be described in detail herein, with the understanding that the description is equally applicable to the other latching system 50 on the opposite side of the blender/juicer 10.

The latching system 50 includes a wire frame arm 52 that is elongate and generally rectangular, with two long side runs 53 and two shorter end runs 54a, 54b that span the ends of the side runs 53. A brace 56 is positioned generally in the center of the arm 52. A rubber knuckle member 60 has a central boss 62 with a through hole 63 through which the upper end run 54a extends. The upper run 54a is free to rotate within the through hole 63, thereby creating a pivot axis P1. At one end, the knuckle member 60 includes a knob 64 with a through hole 65 that receives a pin 66. The pin 66 extends to holes 67 in flanges 68 that extend from a slide member 69 that is mounted on the housing 14 to slide vertically within the recess 40. Thus, the pin 66 defines a second pivot axis P2 for the knuckle member 60. At the end opposite the knob 64, the knuckle member 60 includes two fingers 68a, 68b that form a V-shape.

Referring to FIGS. 4D and 4E, the slide member 69 is slidably mounted on a support 70 that is fixed to the base 12. A spring 71 (FIG. 4E) is in compression and engages the slide member 69 and the support 70. A switch 72, such as a microswitch, is mounted to the support 70 and positioned so that, as the slide member 69 slides upwardly, it engages the switch 72 (see FIG. 4B).

In the blending position shown in FIGS. 3A, 4A, 5 and 6, the latching system 50 is disposed so that the arm 52 is largely below pivot axis P2. The lower end run 54b of the arm 52 is positioned to be captured below the frame 42 of the operating switch 41. The upper end run 54a of the arm 52 is above the pivot axis P2 such that the pivot axis P1 is slightly radially inward of the pivot axis P2. This positioning sets up an “over-center” arrangement of the lower end run 54b, the pivot axis P2, and the pivot axis P1, with the result that the pivot axis P1 is biased toward the housing 14. The compression imparted by the spring 71 on the slide member 69 may help to maintain the lower end run 54b lodged under the frame 42.

It can be seen in FIGS. 4A and 6 that the fingers 68a, 68b capture the collar 18 used in the blending mode. More specifically, the longer finger 68a engages and overlies the upper surface of the housing 14, and the shorter finger 68b engages and underlies the inner surface of the collar 18. Biasing of the knuckle member 60 toward the lower end of the base 12 forces the fingers 68a, 68b against the collar 18 and the housing 14, thereby securing the collar 18 in place. Also, one of two fingers 73 that extend downwardly from within the collar 18 (see FIG. 6A) fits within the hole 46 in the base 12. Insertion of a finger 73 into the hole 46 activates the switch associated with the hole 46, thereby indicating that the blending components are properly in place and blending can commence.

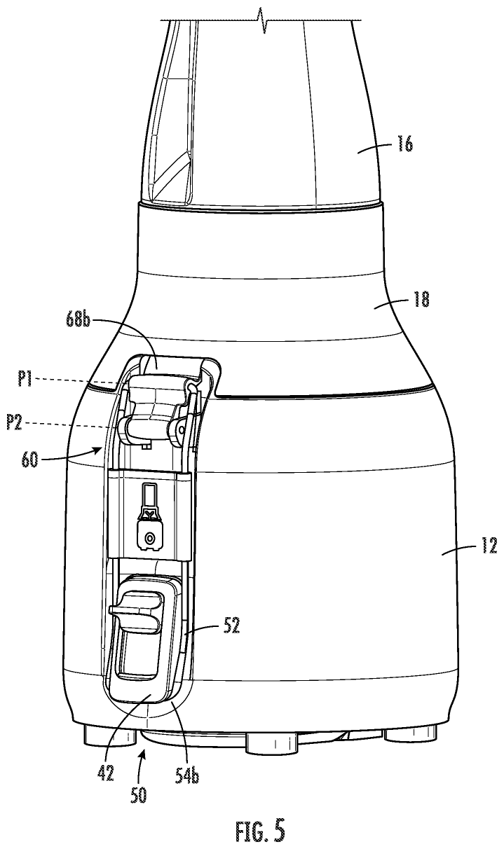

In the illustrated embodiment, the collar 18 is attached to the blender jar 16 via a threaded interface (see FIG. 6), and the blending tool unit 20 (which includes blending blades 22) is mounted onto the fitting 44. These separate components may be mounted on the base 12 together, separately or in combination. For example, in some embodiments, the blending tool unit 20 may be fitted into the inner surface of the blender jar 16 (via a press-fit or interference fit, optionally augmented by a gasket), the blander jar 16 may be screwed onto the collar 18, and the entire assembly may be seated on the housing as shown in FIGS. 5 and 6 as the knuckle member 60 rests with the finger 68a on the upper surface of the housing 14. The arm 52 can then be pivoted about the pivot axis P2 and pulled downwardly until the lower end run 54b “clears” the lower edge of the frame 42, which action forces the fingers 68a, 68b against the upper surface of the housing 14 and the inner surface of the collar 18, respectively. The spring 71 helps to maintain the fingers 68a, 68b (and, in turn, the collar 18, blender jar 16 and blending tool unit 20) in this position.

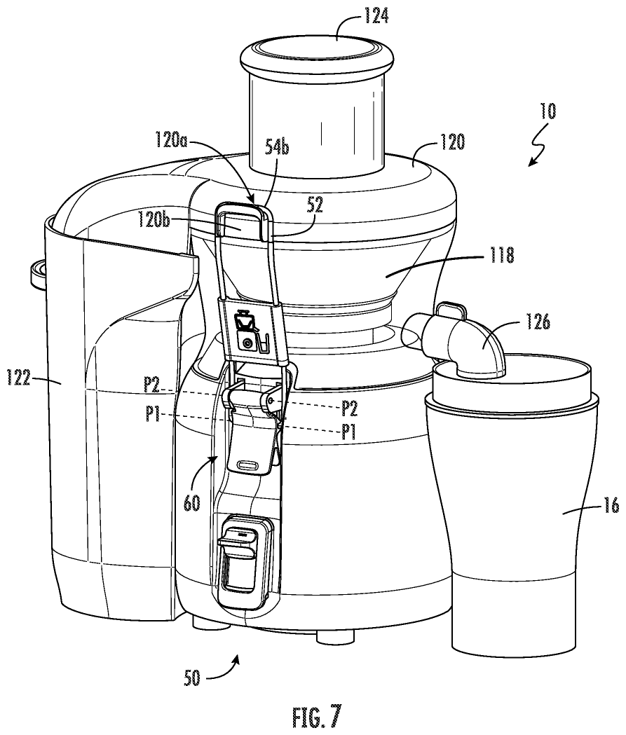

Referring now to FIGS. 3B, 4C-4E, 7 and 8, the latching unit 40 is shown therein in its juicing position. As can be seen in FIGS. 4C and 4D, in the juicing position the knuckle member 60 is rotated about the pivot axis P2 so that the boss 62 and the fingers 68a, 68b are below the pivot axis P2 and the fingers 68a, 68b extend generally downwardly. The arm 52 is rotated about the pivot axis P2 so the arm 52 extends generally upwardly (i.e., generally inverted from its position in the blending position), with the end run 54b at its highest point. As can be seen in FIG. 7, the end run 54b is captured within a groove 120a above a tab 120b in the juicing lid 120. As in the blending position, the latching unit 40 creates an “over-center” arrangement with the end run 54b, the pivot axis P2, and the pivot axis P1. The spring 70 biases the sliding member 69, and in turn the arm 52, downwardly, which may urge the arm 52 to remain captured by the tab 120b.

As shown in FIGS. 7 and 8, in the juicing mode the juicing bowl 118 is mounted onto the housing 14. The pulp receptacle 122 is also mounted onto the housing 14. The lid 120 covers both the juicing bowl and the pulp receptacle 122. FIG. 8 shows the juicing tool unit 130, which includes, inter alia, an inner bowl 132 that includes a cutting/juicing disk at the bottom, and a fitting 134 that is received in the fitting 44 to couple the juicing tool unit 130 to the motor 45. The lid 120 includes a chute 125 that extends both above and below the main surface of the lid 120 to provide a pathway for the pusher 124.

As described above and as can be seen in FIG. 8, when the latching unit 50 is in the juicing position, the arm 52 captures the tab 120a in the lid 120. This secures the lid 120 onto the bowl 118, which in turn forces the bowl 118 onto the upper surface of the housing 14. Securing the lid 120 also secures the pulp receptacle 122 in place to receive pulp produced by the juicing operation. Thus, securing of the latching unit 40 in the juicing position enables the blender/juicer 10 to be used for juicing operations. FIGS. 2 and 7 also illustrate how the blender jar 16 may be positioned beneath the juice outlet 126 in the juicing bowl 118 to receive the juice produced by the blender/juicer 10.

It should also be noted that, in the juicing position, the slide member 69 is positioned upwardly from its location in the blending position (best seen in comparing FIG. 4B to FIG. 4D). This upward movement causes the slide member 69 to engage the switch 72. Such engagement enables the blender/juicer 10 to operate in the juicing mode; conversely, an absence of such engagement prevents the blender/juicer 10 from operating in the juicing mode.

Referring now to FIG. 9, it can be seen that the configuration of the latching unit 40 can prompt the user toward correct usage of the juicer/blender 10. FIG. 9 shows the juicing bowl 118 positioned on the housing 14, presumably for juicing. However, the latching unit 40 is shown in the blending position, with the fingers 68a, 68b of the knuckle member 60 in position to engage the collar 18. Because of the presence of the finger 68b, the juicer bowl 118 cannot be properly and fully seated on the housing 14. Accordingly, the latching unit 40 serves to prevent the arrangement of the components of the blender/juicer 10 in the juicing mode without the proper latching of the juicer bowl 118 onto the housing 14 (i.e., the juicer bowl 118 must be mounted with the latching unit 40 in the juicing position).

Those of skill in this art will appreciate that the juicer/blender 10 may take other forms. For example, the blending and/or juicing components may vary, such that the latching system 40 engages a different component. As one example, the blender/juicer may be configured so that it lacks a blender collar. In such a configuration, the latching system 40 may engage directly the blender jar 16. As another example, the juicing components may be configured such that the lid 120 is secured to the juicer bowl 118 via a press-fit or separate latch, such that the latching system 40 engages the juicer bowl 118 rather than the lid 120. Other configurations may also be imagined.

In addition, in some embodiments either or both of the switches that enable blending/juicing to occur may be omitted, such that the blender/juicer 10 may operate without the need for switch engagement.

Further, the latching system 40 itself may be configured differently. As one example, the arm 52 may be formed of a different material (e.g., a polymeric material). Alternatively, near the lower runs 54b one of the side runs 52 may be open, such that the lower run 54b forms an L-shaped or C-shaped hook for engagement with the frame 22 and the blender bowl 118. As another example, the slide member 69 may be omitted, such that the pivot axis P2 is stationary relative to the housing 14. As still a further example, the knuckle member 60 may have more fingers, only a single finger, and/or may include features on the fingers that improve engagement with the collar 18.

Moreover, the latching system 40 may take another form entirely. As one example, the latching system may comprise an arm that is mounted to the housing 14 to pivot about a horizontal axis that extends radially outwardly from the base 12. Such an arm would include a C-shaped hook on one end and a pair of fingers similar to fingers 68a, 68b on the opposite end. The arm could be rotated about the aforementioned pivot axis to position the C-shaped hook either in engagement with the juicing bowl (for juicing) or with the base, wherein the fingers would secure the collar 18 as described above. Other variations will also be contemplated by those of skill in this art.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as recited in the claims. The invention is defined by the following claims, with equivalents of the claims to be included therein.

That which is claimed is:

1. A blender/juicer appliance, comprising:
a base including a rotary drive unit;
a blender assembly including a blender jar and a blending tool unit, the blending tool unit configured for coupling with the rotary drive unit;
a juicer assembly including a juicing bowl and a juicing tool unit, the juicing tool unit configured for coupling with the rotary drive unit; and
a latch assembly attached to the base and movable between blending and juicing positions, wherein in the blending position, the latch assembly engages the blender assembly to secure the blender assembly to the base, and in the juicing position, the latch assembly engages the juicer assembly to secure the juicer assembly to the base.

2. The blender/juicer appliance defined in claim 1, wherein the latch assembly includes a knuckle member that, in the blending position, is positioned to (a) engage and secure the blender assembly and (b) engage and prevent securing of the juicer assembly.

3. The blender/juicer appliance defined in claim 1, wherein the latch assembly includes an arm member configured so that, in the blending position, the arm member engages a feature on the base, and in the juicing position, the arm member engages a feature on the juicer assembly.

4. The blender/juicer appliance defined in claim 3, wherein in the juicing position the arm member is generally inverted from its orientation in the blending position.

5. The blender/juicer appliance defined in claim 3, wherein the latch assembly includes a knuckle member that is pivotally attached to the arm member at a first pivot axis and to the base at the second pivot axis.

6. The blender/juicer appliance defined in claim 5, wherein in the blending position, the first pivot axis is above the second pivot axis, and in the juicing position, the second pivot axis is above the first pivot axis.

7. The blender/juicer appliance defined in claim 1, wherein the juicer assembly includes a juicer lid that overlies the juicer bowl, and wherein in the juicing position the latch assembly engages the juicer lid.

8. The blender/juicer appliance defined in claim 1, wherein the blender assembly includes a blender collar that engages the base, and wherein in the blending position the latch assembly engages the blender collar.

9. The blender/juicer appliance defined in claim 1, further comprising a switch mounted on the base, the switch positioned and configured (a) to engage with the latching assembly when the latching assembly is in the juicing position to enable the blender/juicer appliance to operate in juicing mode and (b) to prevent the blender/juicer appliance from operating in the juicing mode when the latching assembly is not in the juicing position.

10. A blender/juicer appliance, comprising:
a base including a rotary drive unit;
a blender assembly including a blender jar and a blending tool unit, the blending tool unit configured for coupling with the rotary drive unit;
a juicer assembly including a juicing bowl and a juicing tool unit, the juicing tool unit configured for coupling with the rotary drive unit; and
a latch assembly attached to the base and movable between blending and juicing positions, wherein in the blending position, the latch assembly engages the blender assembly to secure the blender assembly to the base, and in the juicing position, the latch assembly engages the juicer assembly to secure the juicer assembly to the base;
wherein the latch assembly is configured so that, in the blending position, the latch assembly prevents proper engagement of the juicer assembly with the base.

11. The blender/juicer appliance defined in claim 10, wherein the latch assembly includes a knuckle member that, in the blending position, is positioned to (a) engage and secure the blender assembly and (b) prevent proper engagement of the juicer assembly.

12. The blender/juicer appliance defined in claim 10, wherein the latch assembly includes an arm member configured so that, in the blending position, the arm member engages a feature on the base, and in the juicing position, the arm member engages a feature on the juicer assembly.

13. The blender/juicer appliance defined in claim 12, wherein in the juicing position the arm member is generally inverted from its orientation in the blending position.

14. The blender/juicer appliance defined in claim 12, wherein the latch assembly includes a knuckle member that is pivotally attached to the arm member at a first pivot axis and to the base at the second pivot axis.

15. The blender/juicer appliance defined in claim 14, wherein in the blending position, the first pivot axis is above the second pivot axis, and in the juicing position, the second pivot axis is above the first pivot axis.

16. The blender/juicer appliance defined in claim 10, wherein the juicer assembly includes a juicer lid that overlies the juicer bowl, and wherein in the juicing position the latch assembly engages the juicer lid.

17. The blender/juicer appliance defined in claim 10, wherein the blender assembly includes a blender collar that engages the base, and wherein in the blending position the latch assembly engages the blender collar.

18. The blender/juicer appliance defined in claim 10, further comprising a switch mounted on the base, the switch positioned and configured (a) to engage with the latching assembly when the latching assembly is in the juicing position to enable the blender/juicer appliance to operate in juicing mode and (b) to prevent the blender/juicer appliance from operating in the juicing mode when the latching assembly is not in the juicing position.

19. A blender/juicer appliance, comprising:
a base including a rotary drive unit;
a blender assembly including a blender jar and a blending tool unit, the blending tool unit configured for coupling with the rotary drive unit;
a juicer assembly including a juicing bowl and a juicing tool unit, the juicing tool unit configured for coupling with the rotary drive unit; and
a latch assembly attached to the base and movable between blending and juicing positions, wherein in the blending position, the latch assembly engages the blender assembly to secure the blender assembly to the base, and in the juicing position, the latch assembly engages the juicer assembly to secure the juicer assembly to the base, the latch assembly comprising:
an arm member configured so that, in the blending position, the arm member engages a feature on the base, and in the juicing position, the arm member engages a feature on the juicer assembly, wherein in the juicing position the arm member is generally inverted from its orientation in the blending position; and
a knuckle member that is pivotally attached to the arm member at a first pivot axis and to the base at the second pivot axis;
wherein in the blending position, the first pivot axis is above the second pivot axis, and in the juicing position, the second pivot axis is above the first pivot axis.

20. The blender/juicer appliance defined in claim 19, further comprising a switch mounted on the base, the switch positioned and configured (a) to engage with the latching assembly when the latching assembly is in the juicing position to enable the blender/juicer appliance to operate in juicing mode and (b) to prevent the blender/juicer appliance from operating in the juicing mode when the latching assembly is not in the juicing position.
